(19) United States
(12) Patent Application Publication
(10) Pub. No.: US 2007/0195534 A1
(43) Pub. Date: Aug. 23, 2007

(54) Side emitting lens, light emitting device using the side emitting lens, mold assembly for preparing the side emitting lens and method for preparing the side emitting lens

(76) Inventors: Duk Sik Ha, Cheongju-si (KR); Bu Gon Shin, Yuseong-gu (KR); Min Ho Choi, Pohang-si (KR); Jong Hoon Kang, Seoul (KR); Min A. Yu, Yuseong-gu (KR); Jae Seung Lee, Daedeok-gu (KR)

Correspondence Address: MCKENNA LONG & ALDRIDGE LLP, 1900 K STREET, NW, WASHINGTON, DC, 20006, US

(21) Appl. No.: 11/505,829

(22) Filed: Aug. 18, 2006

(30) Foreign Application Priority Data
Aug. 19, 2005 (KR) 2005-76152
Oct. 18, 2005 (KR) 2005-97969
Oct. 18, 2005 (KR) 2005-97999

(51) Int. Cl. F21V 5/00

(52) U.S. Cl. 362/327; 362/329

(57) ABSTRACT

Disclosed are a side emitting lens, a light emitting device using the side emitting lens, a mold assembly for preparing the side emitting lens and a method for preparing the side emitting using the mold assembly. The lens of the present invention has a simple structure so the lens is easily fabricated through a molding process. If the lens is applied to the light emitting member, light generated from the light emitting member is laterally guided by means of the lens.

This application claims the benefit of Korean Patent Application Nos. 10-2005-76152, 10-2005-97969 and 10-2005-97999 filed Aug. 19, 2005, Oct. 18, 2005 and Oct. 18, 2005, respectively in Korea, which are hereby incorporated by reference in their entirety for all purposes as if fully set forth herein.

### TECHNICAL FIELD

The present invention relates to a side emitting lens and a light emitting device using the same. More particularly, the present invention relates to a side emitting lens capable of guiding light generated from a light source in a side direction, a light emitting device using the side emitting lens, a mold assembly for preparing the side emitting lens and a method for preparing the side emitting lens using the mold assembly. If the side emitting lens is employed in a light emitting diode (LED), light generated from the LED is laterally guided by means of the side emitting lens, so that the LED can be used as a light source having side emitting characteristics.

### BACKGROUND ART

As generally known in the art, a light source having side emitting characteristics is used as a backlight unit for a liquid crystal display (LCD). The LCD displays images by using electrical and optical characteristics of liquid crystal. The LCD can be fabricated in a compact size with a light weight as compared with a conventional CRT display device, so that the LCD has been extensively used in monitors, portable phones or television sets, etc.

The LCD includes a liquid crystal control part for controlling liquid crystal and a light source part (backlight unit) for supplying light to the liquid crystal. Conventional LCDs mostly employ a bar-shaped cold cathode fluorescent lamp (CCFL) as a backlight unit thereof. Recently, studies and research have been actively carried out in order to use the LED as a backlight unit for the LCD. If the LED is used as a backlight unit for the LCD, the backlight unit may have a long life span above 50000 hours while representing high brightness. In addition, since the LED does not use heavy metals, such as Hg, it is possible to obtain an environment-friendly LCD with low power consumption.

Recently, light sources having superior side emitting characteristics and capable of lowering power consumption, improving the light emitting efficiency, and mixing red, green and blue colors within a short distance and thus reducing the thickness of backlight units have been spotlighted as backlight units for medium/large-sized LCDs. In this regard, LEDs having superior side emitting characteristics have been increasingly used as light sources.

FIGS. 1 to 3 show lenses used for improving light emitting characteristics of a conventional light emitting device.

FIGS. 1a and 1b illustrate a structure of a conventional hemispherical lens and light emitting characteristics of a conventional light emitting device using the lens. FIG. 1a is a sectional view of the conventional hemispherical lens, which is symmetrically formed about a central axis thereof. A light emitting member, such as an LED, is installed at a center of the conventional hemispherical lens. Although it is not shown in FIGS. 1a and 1b, a transparent molding member (see, FIG. 2) can be installed on the light emitting member in order to prevent the light emitting member from being damaged or contaminated. In addition, FIG. 1b shows the light emitting characteristics of the conventional light emitting device having the hemispherical lens, wherein the light is extensively spread in the central axis direction of the lens, rather than the lateral direction of the lens.

FIGS. 2a to 2c illustrate the molding member installed in the conventional hemispherical lens. Such a molding member may have a spherical shape, a rectangular shape or a spherical-rectangular shape. The shape of the molding member may vary depending on the structure of the lens and a molding material can be filled in a space formed between the molding member and the lens structure. Preferably the molding material should be selected such that the molding member has a refractive index similar to that of the lens. In this case, variation of a light path in a boundary area between the molding member and the lens structure can be minimized.

In the meantime, examples of side emitting lenses capable of laterally guiding the light generated from light sources are disclosed in U.S. Pat. Nos. 6,598,998 and 6,679,621 and Japanese Unexamined Patent Publication Nos. 2004-349660 and 2004-281606.

In particular, U.S. Pat. No. 6,679,621 discloses a light emitting device including an LED and a lens used for guiding the light in the lateral direction of the lens. FIG. 3a shows the structure of the light emitting device disclosed in U.S. Pat. No. 6,679,621 and FIG. 3b shows light emitting characteristics of the light emitting device.

FIG. 3a illustrates a sectional structure of the lens including a reflecting surface formed at an upper portion of the lens for preventing the light from being emitted in the central axis direction of the lens and a refracting surface for guiding the light in a direction perpendicular to the central axis of the lens. If the lens having the above structure is used, as shown in FIG. 3b, it is possible to obtain orientation angle distribution of light emission in a range of about 70 to 80° with respect to the central axis of the lens.

In order to fabricate the lens having the above structure, various fabrication processes, such as turning and grinding processes, are carried out with respect to the lens. In this case, although machining accuracy for the lens can be improved, a process time may be lengthened, so the turning and grinding processes may not be adaptable for mass production of the lens. For this reason, molding processes are advantageously used for mass production of the lens. Among the molding processes, an injection molding process is preferably used for fabricating the lens in mass production. According to the injection molding process, heat is applied to a material in order to melt the material and the melted material is poured into an injection mold. Then, the melted material is cooled for a predetermined period of time to form a product, and then the product is ejected from the injection mold.

However, the conventional side emitting lens as shown in FIG. 3a has a complicated structure, so it is difficult to fabricate the conventional side emitting lens in mass production through the turning and grinding processes or the injection molding process.

FIGS. 4a and 4b schematically illustrate a mold assembly used when the lens shown in FIG. 3a is fabricated through the injection molding process. In order to fabricate the lens through the injection molding process, at least four piece molds are necessary as shown in FIG. 4a. In addition, as shown in FIG. 4b, at least three piece molds are necessary even if the reflecting surface is additionally formed after the injection molding process. Since the mold assembly used in the injection molding process must be designed while taking the fluidity and shrinkage of the melted material into consideration such that molding conditions can be optimized, the actual number of piece molds used in the injection molding process may increase more than expected. Because it is necessary to properly assemble and align the piece molds, continuous and automatic production process may be not easy as the number of the piece molds increases. For instance, if the number of the piece molds is increased, productivity of lenses may be lowered and fabrication and management costs for the piece molds and the mold assembly may increase.

### DISCLOSURE

### Technical Problem

Inventors of the present invention have made research and studies on a side emitting lens capable of guiding light in a direction perpendicular to a central axis of the lens while being fabricated in a simple structure.

Accordingly, an object of the present invention is to provide a lens having side emitting characteristics and being fabricated in a simple structure.

Another object of the present invention is to provide a light emitting device having a side emitting lens.

Further another object of the present invention is to provide a mold assembly to fabricate the side emitting lens. In addition, another object of the present invention is to provide a method for fabricating the side emitting lens using the mold assembly.

### TECHNICAL SOLUTION

As a result, inventors of the present invention discovered that it would be possible to fabricate such a side emitting lens if a recessed reflecting surface is formed at a center portion of an upper surface of a lens and a curved refracting surface is formed at a side portion of the lens such that light emitted towards the upper surface of the lens is laterally reflected by the recessed reflecting surface, and light emitted in various directions, other than the central axis direction, is guided towards the upper surface of the lens.

In order to achieve the above objects, according to one aspect of the present invention, there is provided a lens comprising a bottom surface, a reflecting surface and a refracting surface, wherein the reflecting surface is provided on an upper portion of the lens in a form of a recess, which is downwardly recessed towards the bottom surface about a central axis of the lens, and a sectional area thereof becomes reduced as it reaches the bottom surface; and the refracting surface extends from the edge of the bottom surface to the reflecting surface in the curved form.

According to another aspect of the present invention, there is provided a light emitting device having the structure wherein a light emitting member is installed on a bottom surface of the lens. The light emitting member includes an light emitting diode (LED). That is, the present invention provides the light emitting device including the light emitting diode (LED) installed on the bottom surface of the lens.

According to still another aspect of the present invention, there is provided a mold assembly for fabricating the lens. The mold assembly comprises a first mold having a cavity to form a reflecting surface and a refracting surface of the lens, and a second mold matching with the first mold and having a cavity to form a bottom surface of the lens.

The section of the cavity of the first mold, which corresponds to the reflecting surface of the lens, is downwardly recessed about the central axis of the lens, and the sectional area thereof becomes reduced as it reaches the lowest end portion of the cavity of the first mold.

The section of the cavity of the first mold, which corresponds to the refracting surface of the lens, extends in the curved form from the external diameter portion of the cavity of the second mold, which corresponds to the bottom surface of the lens, to the section of the first mold, which corresponds to the reflecting surface of the lens.

The side emitting lens according to the present invention can be fabricated by use of the mold assembly comprising only two piece molds.

According to still yet another aspect of the present invention, there is provided a method of fabricating the lens by using the mold assembly. The mold assembly for fabricating the side emitting lens according to the present invention has such a simple structure that it can be easily applied to mass production.

In addition, the present invention provides a method of fabricating the light emitting device including the lens and the light emitting member.

Hereinafter, the present invention will be described with reference to accompanying drawings.

A lens according to the present invention includes a bottom surface (1), a reflecting surface (2) and a refracting surface (3) as can be seen in FIGS. 5a, 5d and 5e. The lens can guide light generated from a light source in a direction perpendicular to a central axis of the lens. Thus, a light emitting device having side emitting characteristics can be obtained by installing a light emitting member at a predetermined portion of the bottom surface of the lens as a light source.

The reflecting surface (2) in the form of a recess is provided at a center portion of an upper portion of the lens in order to laterally reflect the light being emitted towards the upper surface of the lens. The light reflected from the reflecting surface is refracted through the refracting surface so that the light is emitted out of the lens in a direction substantially perpendicular to the central axis of the lens.

The refraction surface (3) is a curved surface extending from the edge of the bottom surface to the reflecting surface in the curved form, which refracts the light arriving at the refracting surface so that the light is emitted out of the lens in a direction substantially perpendicular to the central axis of the lens.

In the present invention, the term “side emitting lens” refers to a lens capable of guiding light generated from a light emitting member in a direction perpendicular to the central axis of the lens. In addition, a light emitting device capable of emitting light in a direction perpendicular to the central axis of the lens is called a “side emitting light emitting device.”

Accordingly, a light emitting device capable of laterally emitting light generated from a light emitting member by using the side emitting lens according to the present invention is also called a “side emitting light emitting device” even if the light emitting member has no side emitting characteristics.

The lens according to the present invention can guide the light in the lateral direction thereof and has a simple structure as compared with the conventional lens (see, FIGS. 3a, 4a and 4b) so that it can be easily fabricated in mass production with improved productivity.

The lens according to the present invention can be fabricated through an injection molding process by using a reduced number of piece molds, that is, by using two piece molds (see, FIGS. 6a and 6b). If the number of piece molds is reduced, products can be easily ejected from the injection mold assembly so that the process time can be reduced, thereby improving productivity. In addition, as the number of piece molds becomes reduced, it is possible to simplify designs for continuous production and equipment automation, so the processes can be easily carried out and the mass production system is applicable for fabricating the lens according to the present invention.

According to the present invention, the lens has a substantially hemispherical shape, rather than a completely hemispherical shape. Exemplary embodiments of the lens according to the present invention are shown in FIGS. 5a, 5d and 5e. According to the present invention, an external semi-diameter (5) of the bottom surface of the lens is larger than a height (4) of the lens measured along the central axis direction thereof (see FIGS. 5d and 5e). According to one embodiment of the present invention, the bottom surface of the lens is formed in a circular shape about the central axis of the lens. In addition, a ratio of the height of the lens to the external semi-diameter of the bottom surface of the lens, (height of the lens):(external semi-diameter of the bottom surface of the lens), is within a range of about 0.5 to 0.9:1. Preferably, the lens according to the present invention is symmetrically formed about the central axis thereof.

The lens according to the present invention includes a reflecting surface (2) in the form of a recess, which is formed at the upper surface of the lens and open toward upside. The width of the recess becomes narrowed as it reaches the bottom surface of the lens. The present invention does not limit the shape of the reflecting surface formed at the upper surface of the lens. Preferably, the reflecting surface is symmetrically formed about the central axis of the lens in order to facilitate the fabrication of the lens.

For the purpose of explanation, the structure of the reflecting surface can be divided into a side section (2a) and a lower end portion (2b) (see FIG. 5d).

According to one exemplary embodiment of the present invention, the reflecting surface includes a horizontal part, which is perpendicular to the central axis of the lens. Preferably, the horizontal part can be formed in the lower end portion of the reflecting surface. The shape and the size of the recess defined by the reflecting surface may vary depending on application of the lens and the kind of light emitting members installed on the lens. When the light emitting member is installed on the lens, a sectional area of an upper end portion of the recess is preferably identical to or larger than a light emitting area of the light emitting member and a sectional area of a lower end portion of the recess is preferably smaller than the light emitting area of the light emitting member.

According to one exemplary embodiment of the present invention, a diameter of the upper end portion of the recess may be 2 to 6 times the diameter of the lower end portion of the recess. If the diameter of the upper end portion of the recess is too large, it is difficult to obtain total reflection at the reflecting surface. In addition, if the diameter of the upper end portion of the recess is too small, side emitting characteristics of the light emitted through the lens may be degraded.

The recess can be shaped in the form of a circular truncated cone, more precisely an “overturned circular truncated cone,” which is also called a “funnel shape”.

According to one embodiment of the present invention, the side section (2a) of the reflecting surface can be formed as a smooth surface or a stepped surface. In addition, the side section of the reflecting surface may include at least two planes having mutually different gradients and being connected to each other. FIG. 5c shows various sectional shapes of the recess defined by the reflecting surface. However, the present invention may not limit the shapes of the reflecting surface as shown in FIG. 5c, but various modifications thereof can be embodied according to the present invention. Preferably, an angle between the side section (2a) and the central axis of the lens is about 5 to 50°. More preferably, the side section is inclined from the central axis of the lens at an angle of about 10 to 30° in order for obtaining total reflection at the reflecting surface. If the angle between the reflecting surface and the central axis of the lens is too large, it is difficult to obtain total reflection at the reflecting surface. In addition, if the angle between the reflecting surface and the central axis of the lens is too small, side emitting characteristics of the light emitted through the lens may be degraded.

The lower end portion (2b) of the reflecting surface may be vertical to the central axis of the lens or inclined from the central axis of the lens at a predetermined angle.

In order to allow the reflecting surface to reliably reflect light, the recess of the lens forming the reflecting surface can be coated with Ag, Al, or the like. That is, the surface of the recess is treated with Ag or Al through a deposition process, a coating process or a plating process after the lens has been fabricated in such a manner that the reflection efficiency of the reflecting surface can be improved. In addition, a fluorescent material can be coated on the reflecting surface, if necessary.

According to the present invention, a curved refracting surface (3) is formed at the side portion of the lens extending from the edge of the bottom surface (1) of the lens to the reflecting surface (2). If the light emitting member is installed on the bottom surface of the lens, most of the light emitted from the light emitting member may finally be emitted to the exterior through the refractive surface. At this time, the light is refracted because the refractive index of the lens is different from the refractive index of the exterior (for example, the refractive index of air). As a result, the light can be emitted in a direction substantially perpendicular to the central axis of the lens. Such refraction of the light may occur according to Snell' law. Therefore, those skilled in the art may predict and determine the light path based on Snell' law, so that it is possible to properly design the shape of the refracting surface by taking Snell' law into consideration.

Preferably, the refracting surface is symmetrically formed about the central axis of the lens. A vertical section of the refracting surface, that is, a cross-sectional region of the refracting surface including the central axis of the lens may be formed as a part of a Bezier curve, an oval or a parabola.

Hereinafter, the light emitting characteristics of the light emitting device according to the present invention will be described with reference to FIGS. 5a and 8.

First, if the light generated from the light emitting member installed on the bottom surface of the lens is emitted towards the curved section of the lens, that is, refracting surface (3), the light is refracted by means of the refracting surface so that the light path is changed. That is, the light is refracted in a direction nearly perpendicular to the central axis of the lens, so that the side emitting of the light is induced.

In addition, if the light generated from the light emitting member is emitted towards the reflecting surface along the central axis of the lens, the light is reflected from the reflecting surface so that the light is guided towards the refracting surface of the lens, and as a result, the light is refracted in a direction perpendicular to the central axis of the lens, so that the side emitting of the light is induced. The light is mostly emitted out of the lens along the main light path shown in FIGS. 5a and 8. In the meantime, some of the light reflected from the reflecting surface may not be directly guided towards the refracting surface. That is, some of the light may be reflected several times between the reflecting surface of the lens and the light emitting member before it is emitted out of the lens. In this case, the light efficiency, especially, the light extraction efficiency becomes degraded. However, an amount of the light reflected between the reflecting surface of the lens and the light emitting member is very little in comparison with the total amount of the light.

A groove can be formed at the bottom surface of the lens about the central axis of the lens in order to install the light emitting member in the groove as a light source. According to one embodiment of the present invention, the light emitting member includes a light emitting diode (LED). In addition, those skilled in the art may selectively determine the size of the groove according to application of the lens, the kind and size of light emitting members to be installed in the groove, and workability for the lens.

According to the present invention, the lens can be fabricated through conventional fabrication processes. That is, the lens of the present invention can be fabricated by turning and grinding a transparent material or by molding light transmissive resin. In addition, the lens can be fabricated by curing photo-curable resin.

According to one exemplary embodiment of the present invention, the lens is fabricated by injection-molding light transmissive resin.

The light transmissive resin includes, but not limited thereto, cyclic olefin copolymer (COC), acryl resin, polycarbonate (PC), PC/PMMA copolymer, silicone, fluorocarbon resin, polyetherimide (PEI) or polynorbornene (PNB). According to one embodiment of the present invention, acryl resin is used as the light transmissive resin. The acryl resin includes polymethylmeta acrylate (PMMA), urethane acrylate, epoxy acrylate, ester acrylate and a mixture thereof.

The lens according to the present invention has a refractive index of about 1.3 to 1.8. For instance, if the lens is fabricated by using the acryl resin, the lens has a refractive index in a range of about 1.3 to 1.8.

Considering the structure of the lens according to the present invention, those skilled in the art can properly fabricate the piece molds or mold assembly to be used for the injection molding process.

FIGS. 6a and 6b according to one exemplary embodiment of the present invention illustrate the structure of the mold assembly for injection molding process to prepare the lens. The lens according to the present invention can be fabricated through the injection molding process using only two piece molds.

In order to fabricate the side emitting lens having the bottom surface, the reflecting surface and the refracting surface, the mold assembly according to the present invention requires molding cavities, which correspond to the bottom surface, the reflecting surface and the refracting surface of the lens. The mold assembly according to the present invention may include preferably two piece molds. i.e., a first mold having a cavity to form the reflecting surface and the refracting surface, and a second mold matching with the first mold and having a cavity to form the bottom surface.

The cavity of the first mold, which corresponds to the reflecting surface of the lens, is downwardly recessed about the central axis of the lens, and the sectional area thereof becomes reduced as it reaches the bottom portion of the cavity of the first mold. The section of the first mold, which corresponds to the refracting surface of the lens, extends in the curved surface form from the external diameter portion of the cavity of the second mold, which corresponds to the bottom surface of the lens, to the section of the first mold, which corresponds to the reflecting surface of the lens. The section of the first mold, which corresponds to the reflecting surface of the lens, may include at least two planes having mutually different gradients and being connected to each other. The section of the first mold, which corresponds to the refracting surface of the lens, may be formed as a part of a Bezier curve, an oval or parabola.

The cavity of the second mold may include a receiving space in order to install the light emitting member.

As the lens is fabricated in the state that the light emitting member is installed within the mold assembly, the cavity of the second mold may include a space, which receives a means for installing the light emitting member. A groove may be formed in the means for installing the light emitting member so that the light emitting member is easily installed within the molding cavity.

The section of the cavity of the first mold, which corresponds to the reflecting surface of the lens, may be pointed or flat at the end portion. FIG. 5c illustrates the reflecting surface, which is formed by the cavity according to one exemplary embodiment of the present invention.

The first mold may include one or at least two molds. Each of the two molds to form the first mold may include molding cavities for forming at least a portion of the reflecting surface and the refracting surface of the lens. In other words, the first mold may be divided into two molds. In addition, the first mold may also be divided into a mold for forming a recessed portion for forming the reflecting surface and a mold for a curved portion for forming the refracting surface. Each of piece molds and the mold assembly can be modified in order to facilitate the ejection process after the molding.

In consideration of the structure and design of the lens, those skilled in the art can adopt proper material, size and shape for the preparation of the piece molds and mold assembly, and can prepare the piece molds and mold assembly through a conventional method. The lens fabricated by using the mold assembly is a light transmissive lens, which can be fabricated by performing an injection molding process using light transmissive resin. As such, the material for the molds should not be transformed at the melting temperature of the light transmissive resin. Preferably, the molds can be prepared by using a material, which is not transformed at 400° C. or less in consideration of the melting temperature of the light transmissive resin. In other words, material, which is transformed at a higher temperature than 400° C., can be used for preparing the molds. Such material may preferably be metal or metal alloy. The molds can be prepared in mass production by use of SUS type, aluminum alloy, etc.

Prior to preparing the molds for the side emitting lens, the structure and shape of the side emitting lens to be fabricated by the molds need to be determined. Once the structure and shape of the side emitting lens are determined, the molds can easily be prepared based on such structure and shape of the side emitting lens.

In the field of molding, a mold assembly is generally referred to as “mold,” and each piece mold constituting the mold assembly is also generally referred to as “mold.” The two piece molds according to the present invention will be referred to as “first mold” and “second mold,” respectively. An assembly of these molds will be referred to as “a mold assembly.”

According to the present invention, a light emitting device can be prepared by installing a light emitting member on the bottom surface of the lens. Such a light emitting device is a side emitting light emitting device, which includes a light emitting member and a side emitting lens. In the above light emitting device, the light emitting member is mounted on the bottom surface of the lens. According to one embodiment of the present invention, the light emitting device includes an LED.

In addition, a groove can be formed in the bottom surface of the lens in order to install the light emitting member in the groove. At this time, a sectional area of a lower end portion (2b) of a recess defined by the reflecting surface is preferably smaller than the light emitting area of the light emitting member. In addition, a sectional area of an upper end portion of the recess is preferably identical to or larger than the light emitting area of the light emitting member. The sectional area of the upper end portion of the recess can be selectively decided by those skilled in the art.

A distance between the light emitting member and the lower end portion (2b) of the reflecting surface may vary depending on the size and application of the lens. According to one embodiment of the present invention, the distance preferably corresponds to 40 to 100% of the longest side or the diameter of the light emitting area of the light emitting member. The conditions for total reflection may vary depending on the above distance. In addition, the path of light generated from the light emitting member can be changed according to the above distance while it is being reflected from the reflection surface and an amount of light guided in the lateral direction of the lens may vary depending on the above distance. Therefore, if the light emitting member is aligned out of the above distance range, desired light emitting characteristics may not be obtained. The above distance can be adjusted by those skilled in the art.

The light emitting device according to the present invention can be obtained by fixedly installing the light emitting member on the bottom surface of the lens using a molding member. When the light emitting member is installed in the groove formed in the bottom surface of the lens, a gap may be formed between the light emitting member and an inner wall of the groove. In this case, the gap is filled with the molding member. In addition, if a space is formed between the light emitting member and the inner portion of the lens, the space can be filled with the molding member.

The molding member includes light transmissive resin or silicone. Preferably, the molding member has a refractive index similar to that of the lens. In this case, refraction of light emitted from the light emitting device can be minimized, thereby reducing light loss. The molding member and the lens can be made from the same material or mutually different materials. In a case of a high power LED, a silicone-based internal molding member is used as a molding member. The silicone-based internal molding member can prevent the lens from being deformed due to heat generated from the light emitting device. A wire bonding of the light emitting device may be broken if the lens frequently undergoes thermal deformation. The molding member, especially, the silicone-based internal molding member prevents the lens from being thermally deformed so that the wire bonding of the light emitting device may not be broken.

According to another embodiment of the present invention, it is also possible to fabricate the light emitting device by inserting the light emitting member into the mold assembly. In this case, the light emitting member is inserted into the mold assembly and then injection molding is performed using light transmissive resin, so that the lens including the light emitting member therein can be fabricated.

### ADVANTAGEOUS EFFECTS

The side emitting lens according to the present invention includes the curved refracting surface and the recessed reflecting surface for guiding the light emitted from the light emitting member in the side direction. In addition, the light emitting device prepared by use of the side emitting lens may represent orientation angle distribution of the side direction in a range of about 70 to 80°. The lens of the present invention can be fabricated with a simple structure while representing superior orientation angle distribution, so that the lens can be easily fabricated in mass production through the injection molding process.

In addition, the molds of the present invention have the simple structure and thus are useful for the injection molding process. The side emitting lens fabricated by use of the molds has a simple structure while representing the superior orientation angle distribution.

### DESCRIPTION OF DRAWINGS

The above and other objects, features and advantages of the present invention will be more apparent from the following detailed description taken in conjunction with the accompanying drawings, in which:

FIG. 1a is a cross-sectional view illustrating a conventional light emitting device including a hemispherical lens and an LED as a light emitting member.

FIG. 1b is a view illustrating orientation angle distribution as light emitting characteristics of a conventional hemispherical light emitting device.

FIGS. 2a to 2c are sectional views illustrating a molding member installed in a hemispherical lens of a light emitting device shown in FIG. 1a, in which FIG. 2a shows a rectangular molding member, FIG. 2b shows a substantially oval-shaped molding member, and FIG. 2c shows a hemispherical molding member.

FIG. 3a is a sectional view illustrating a structure of a lens used in a conventional light emitting device having side emitting characteristics.

FIG. 3b is a view illustrating orientation angle distribution as light emitting characteristics of a conventional light emitting device.

FIG. 4a is a view illustrating a mold assembly including four piece molds assembled with each other to fabricate a lens shown in FIG. 3a.

FIG. 4b is a view illustrating another mold assembly including three piece molds assembled with each other to fabricate a lens shown in FIG. 3a, wherein an additional process is necessary for fabricating the lens after an injection molding process using the mold assembly has been finished.

FIG. 5a is a view illustrating a light emitting device having side emitting characteristics according to one exemplary embodiment of the present invention, in which an LED is installed in a lens of the light emitting device as a light emitting member.

FIG. 5b is a view illustrating a Bezier curve used for determining a curve of a refracting surface of a lens when fabricating the lens according to one exemplary embodiment of the present invention;

FIG. 5c is a view illustrating various shapes of end portions of recesses that can be formed in lenses according to embodiments of the present invention.

FIGS. 5d and 5e are view illustrating each portion of the lens according the present invention.

FIGS. 6a and 6b are views illustrating a mold assembly including two piece molds for fabricating a lens according to one exemplary embodiment of the present invention.

FIG. 7a is a view illustrating the structure of a lens in a three-dimensional image according to one exemplary embodiment of the present invention.

FIG. 7b is a view illustrating orientation angle distribution as light emitting characteristics of a lens shown in FIG. 7a.

FIG. 8 is a view illustrating paths of light, which is reflected and refracted by means of a lens according to one exemplary embodiment of the present invention.

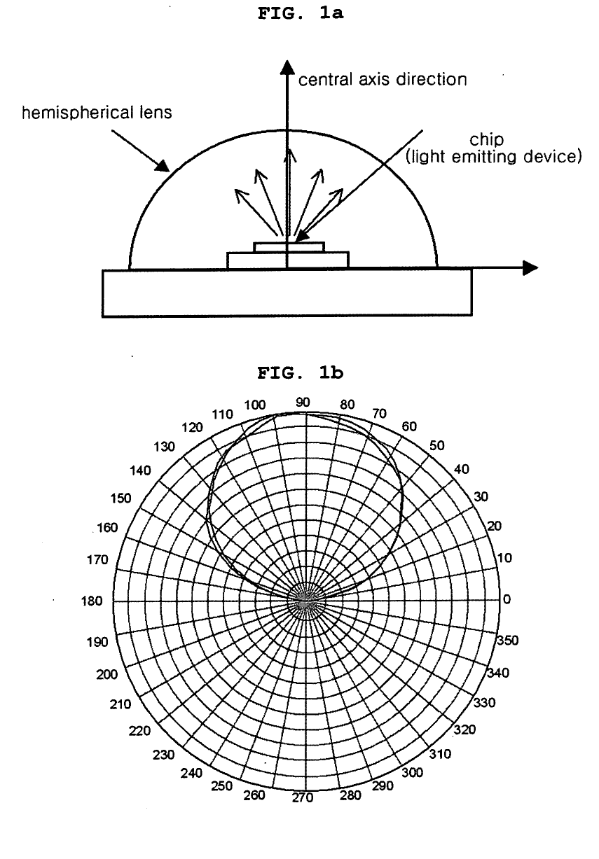

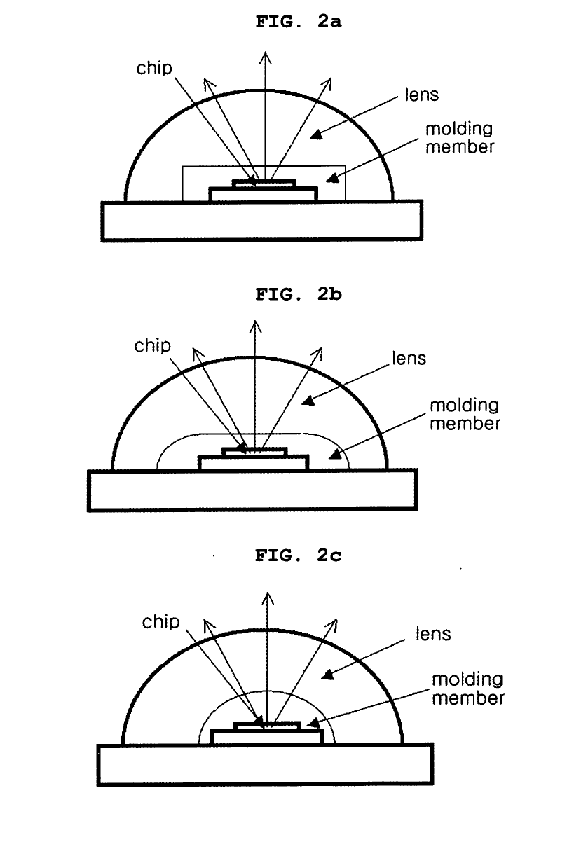

### BRIEF DESCRIPTION OF THE INDICATIONS

1: bottom surface of the lens

2: reflecting surface of the lens

2a: side section of reflecting surface

2b: lower end portion of the reflecting surface

3: refracting surface of the lens

4: height of the lens

5: external semi-diameter of the bottom surface of the lens

### Best Mode

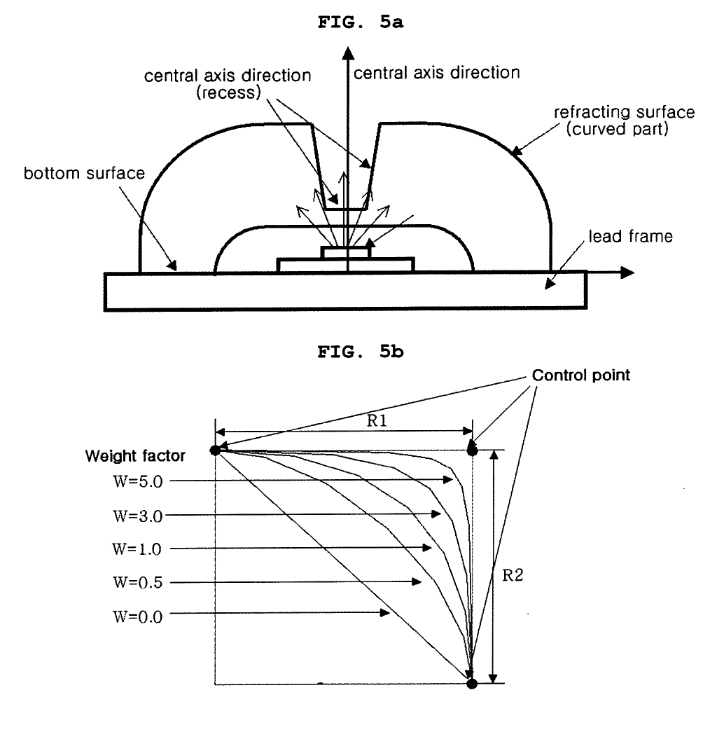

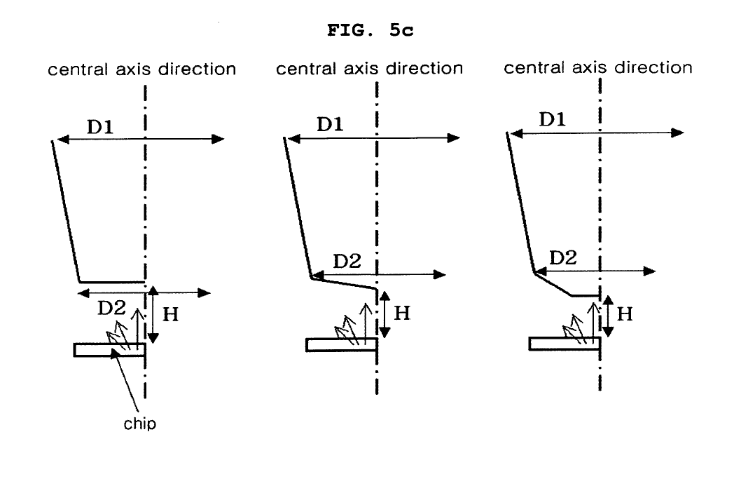

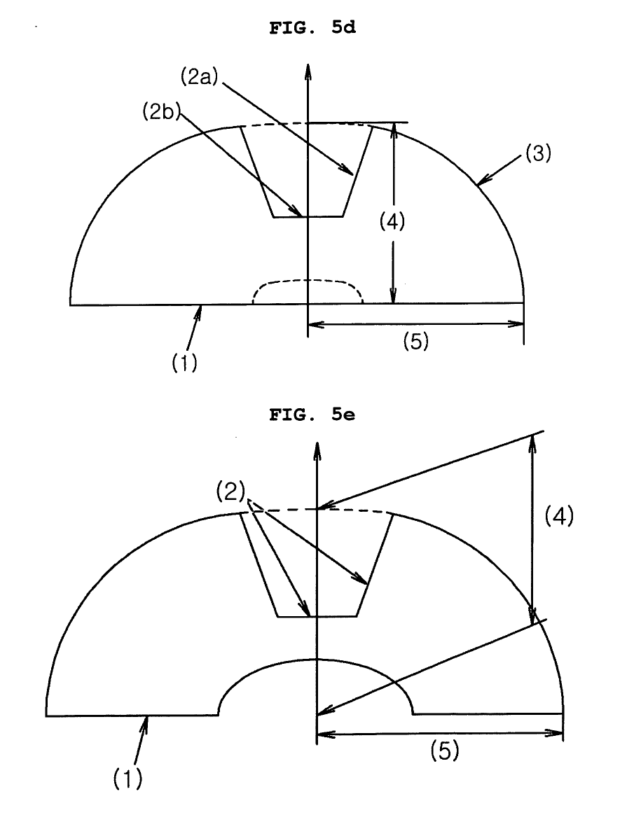

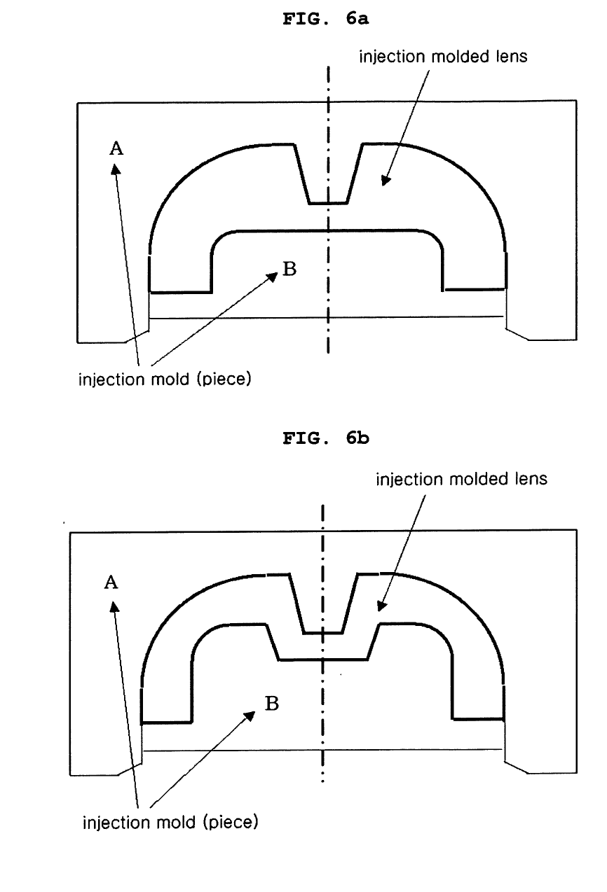

Hereinafter, the present invention will be described in detail with reference to FIGS. 5a and 6b.

FIG. 5a is a view illustrating the light emitting device having side emitting characteristics according to one embodiment of the present invention, in which the LED is installed in the groove formed in the bottom surface of the side emitting lens.

The lens has a simple structure so that it can be easily fabricated through an injection molding process by using two piece molds. The lens includes the curved refracting surface and the recessed reflecting surface. A shown in FIG. 5a, the refracting surface provided at both side portions of the lens is in the form of a smooth curve. The refracting surface can be designed by using a curve having a single radius or a Bezier curve. The size of the single radius may vary depending on peripheral equipment, such as a lead frame for coupling the lens in a circuit board for application, or a diameter D1 of a hole (recess) shown in FIG. 5a. According to one embodiment of the present invention, the single radius is about 1 to 2 mm.

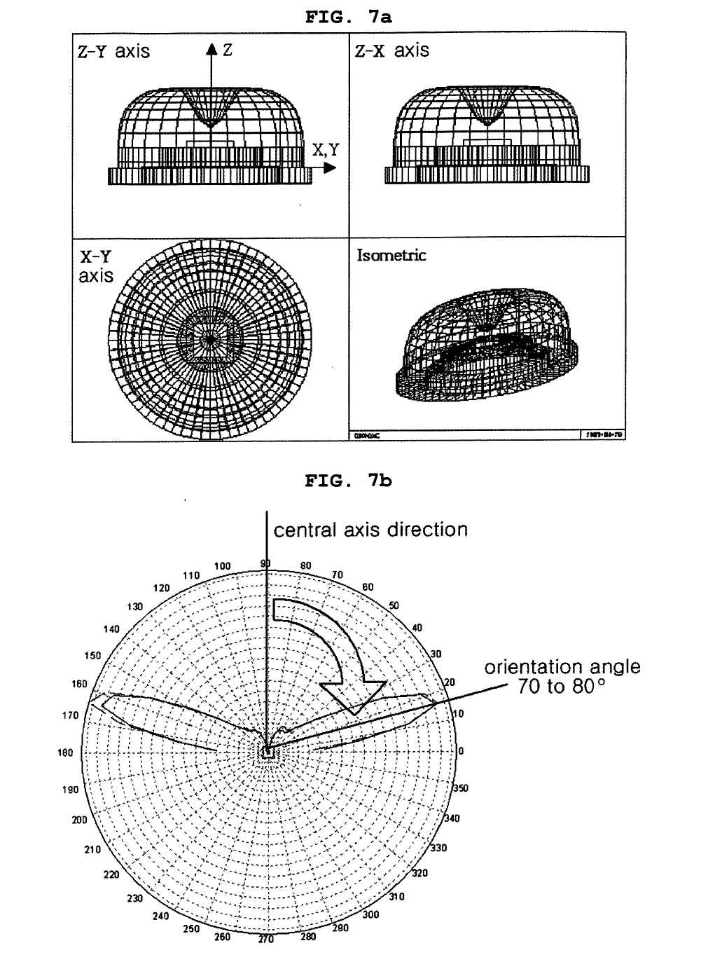

In addition, the refracting surface of the lens can be obtained by mathematically creating the Bezier curve, which smoothly extends from the bottom surface to the reflecting surface provided at the upper portion of the lens. FIG. 7a illustrates the outer appearance of the lens in a three-dimensional image.

The shape of the reflecting surface (2) formed at the upper portion of the lens is illustrated in FIGS. 5a and 5c. However, the present invention is not limited thereto. The reflecting surface (2) is provided in the form of a recess, which is downwardly recessed from the upper portion of the lens towards the bottom surface (1) of the lens. At this time, a sectional shape of a sidewall of the recess may include at least one straight line having a predetermined gradient. In addition, the diameter D1 of the upper end portion of the recess is different from the diameter D2 of the lower end portion of the recess and the diameter of the recess becomes reduced as it reaches the bottom surface of the lens (D1>D2) in order to laterally refract the light (see FIG. 5c).

The diameter D1 of the upper end portion of the recess may vary depending on the size of the light emitting member. Preferably, the upper end portion of the recess is designed such that it can prevent the light generated from the light emitting member from being emitted out of the lens along the central axis of the lens. Accordingly, the diameter D1 of the upper end portion of the recess is adjusted such that the upper end portion of the recess can cover the whole area of the light emitting member when the light emitting member emits the light along the central axis direction of the lens.

A distance between the upper end portion and the lower end portion of the recess, that is, the depth of the recess can be obtained by determining the distance between the light emitting member installed on the bottom surface of the lens and the lower end portion of the light reflecting surface. That is, the depth of the recess can be calculated based on a vertical distance (H) between the lower end portion of the reflecting surface and the light emitting member. According to one embodiment of the present invention, the vertical distance (H) between the light emitting member and the lower end portion of the light reflecting surface corresponds to 40 to 100% of the longest side of the light emitting member or the diameter of the light emitting member if the light emitting member has a circular shape. The actual distance may be determined by taking the sizes of the light emitting member and the lens into consideration.

FIGS. 6a and 6b illustrate the structure of a mold assembly for injection molding process and an assembling method thereof used for fabricating the lens shown in FIG. 5a according to one embodiment of the present invention. If the lens is fabricated by the injection molding process using the mold assembly shown in FIGS. 6a and 6b, the lens has a simple structure so that the lens can be easily ejected from the mold assembly. Thus, the lens can be simply fabricated by using a mold assembly having two molds. If the light emitting device is fabricated by using the LED, which has a size of 1 mm×1 mm and is installed on the lens shown in FIG. 5a as a light emitting member, it is possible to obtain orientation angle distribution in a range of about 70 to 80°.

### EXAMPLE 1

### Fabrication of the Mold Assembly and Side Emitting Lens

According to Example 1, acryl resin is subject to an injection molding process by using the mold assembly shown in FIG. 6a in order to fabricate the lens as shown in FIG. 5a.

First, the lens shown in FIG. 5a is designed.

In the present example, the curved refracting surface is designed by using the secondary Bezier curve as shown in FIG. 5b. At this time, a weight factor has a value between 0.5 and 3 and x and y components of a control point are determined as R1 and R2, which are distances among three points. For reference, the above values may vary depending on the structure of the light emitting device.

The external semi-diameter of the bottom surface of the lens is 2.8 mm and the height of the lens in the central axis direction thereof is 1.8 mm.

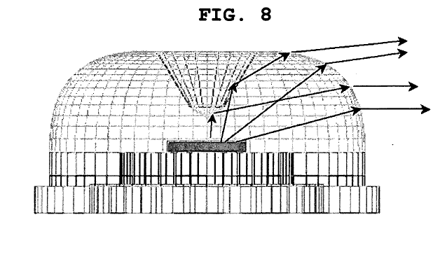

The shape of the reflecting surface is shown in FIG. 8 and FIG. 5c (middle part).

The LED having a size of 1 mm×1 mm and a thickness of 0,2 mm is used in the present example as a light emitting member, so the diameter D1 of the upper end portion of the recess (reflecting surface) is set to 1.8 mm such that the upper end portion of the recess can cover the whole area of the rectangular LED having a volume of 1 mm².

The lower end portion of the reflecting surface is formed according to FIG. 5c (middle part)(refer to FIG. 8). The diameter D2 of the lower end portion of the reflecting surface is 0.7 mm. In addition, the groove is formed in the bottom surface of the lens in such a manner that the vertical distance (H) between the light emitting member installed in the groove and the lower end portion of the reflecting surface is set to 0.7 mm. The three-dimensional structure of the lens may be obtained by axisymmetrically rotating the structure of the lens shown in FIG. 5a about the central axis of the lens. The three-dimensional structure of the lens is shown in FIG. 7a in detail.

A mold assembly shown in FIG. 6a is fabricated based on the structural design described above in order to fabricate the lens shown in FIG. 5a. In FIG. 6a, “A” is the first mold and “B” is the second mold.

In order to fabricate the lens as shown in FIG. 5a by using the above lens structure, polymethylmeta acrylate (PMMA), which is light transmissive acryl resin, is subject to the injection molding process by using the mold assembly shown in FIG. 6a, thereby fabricating the lens.

### EXAMPLE 2

### Fabrication of the Light Emitting Device

In Example 2, a light emitting device is fabricated by using the lens fabricated through Example 1. That is, after installing the LED in the groove formed on the bottom surface of the lens as a light emitting member, the space formed between the LED and the inner portion of the lens is filled with polymethylmeta acrylate (PMMA) to fix the LED (1 mm×1 mm×0,2 mm), thereby fabricating the light emitting device. At this time, the center of the LED is aligned in line with the central axis of the lens.

### EXAMPLE 3

### Fabrication of a Light Emitting Device

When fabricating the first mold and the second mold according to Example 1, a groove is formed for installing a light emitting member in the second mold. The light emitting member is installed in the groove and the first mold and the second mold are assembled. A light transmissive resin is injected into the cavity of the assembled molds (mold assembly), and is cured so as to fabricate a light emitting device including the light emitting member.

In other words, a light emitting diode (LED), which is a light emitting member, is installed in the second mold. Then, polymethyl methacrylate, which is a light transmissive resin, is subject to a injection molding process so as to fabricate a light emitting device, in which the light emitting diode (1 mm×1 mm×0.2 mm) is installed (see FIG. 5a). In this case, the center of the light emitting diode is located in the central axis of the lens.

FIG. 7b illustrates orientation angle distribution of the lens shown in FIG. 5a. The orientation angle distribution is calculated by using an ASAP, which is an optical analysis program. According to the orientation angle distribution shown in FIG. 7b, the light generated from the LED is mainly emitted in the lateral direction of the lens, rather than the upward direction of the lens and is distributed in a range of about 70 to 80° with respect to the central axis of the lens.

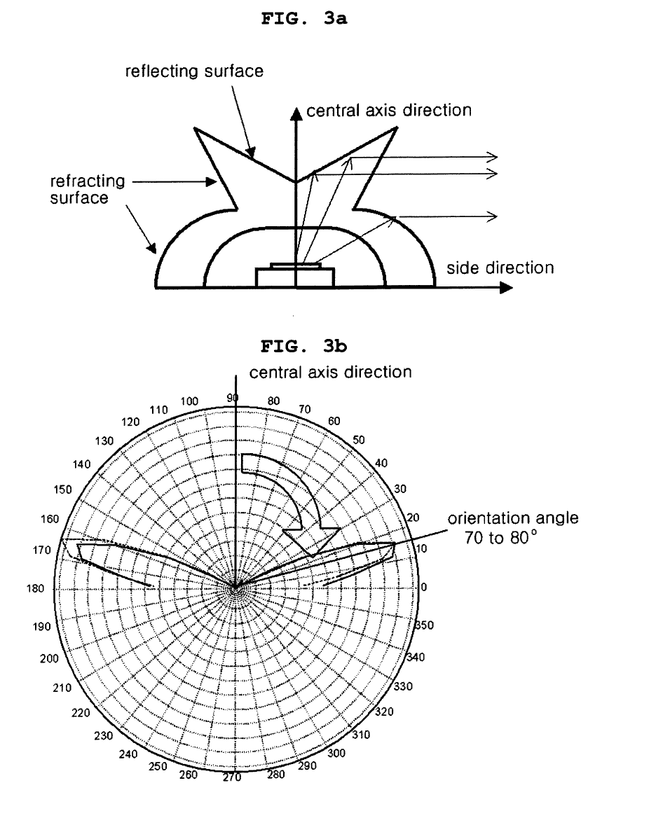

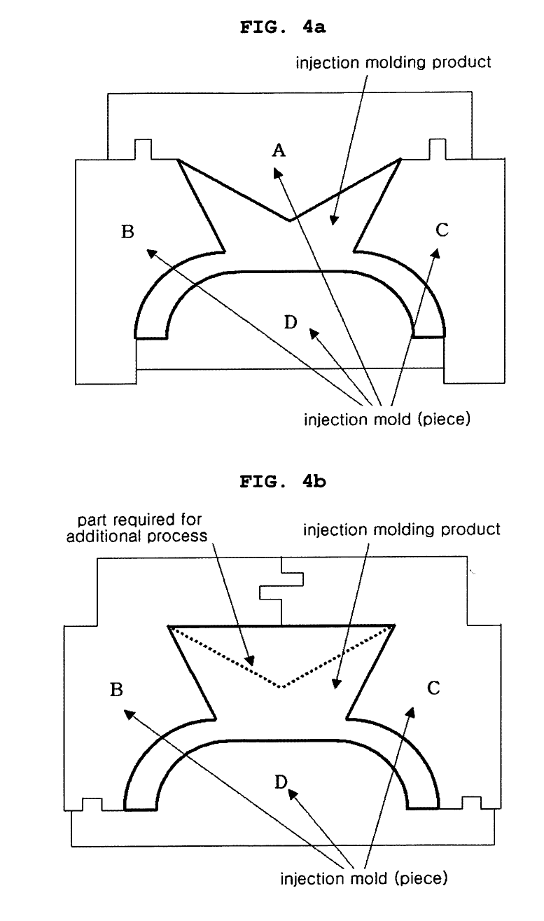

The above orientation angle distribution is substantially identical to the orientation angle distribution of the conventional side emitting lens shown in FIG. 3a. However, the lens and the light emitting device according to the present invention can be easily fabricated by using a reduced number of piece molds having the simple structure.

### INDUSTRIAL APPLICABILITY

The side emitting lens according to the present invention is superior in guiding the light emitted from the light emitting member. As such, the light emitting device fabricated by use of the lens may represent orientation angle distribution of the side direction in a range of about 70 to 80°. Such a light emitting device can be applied to the products, which require a side light emitting source. In particular, the light emitting device can be used as a back light of LCD. In addition, since the molds according to the present invention has the simple structure, they are useful for the injection molding process.

1. A lens comprising a bottom surface, a reflecting surface and a refracting surface,
wherein the reflecting surface is provided on an upper portion of the lens in a form of a recess, which is downwardly recessed towards the bottom surface about a central axis of the lens, and a section area thereof becomes reduced as it reaches the bottom surface; and
the refracting surface extends from the bottom surface to the reflecting surface in a form of a curved surface.

2. The lens according to claim 1, wherein the bottom surface is formed in a circular shape about the central axis of the lens and a external semi-diameter of the bottom surface is larger than a height of the lens.

3. The lens according to claim 2, wherein a ratio of the height of the lens in the direction of the central axis to the external semi-diameter of the bottom surface of the lens, (height of the lens): (external semi-diameter of the bottom surface of the lens), is about 0.5 to 0.9:1.

4. The lens according to claim 1, wherein the reflecting surface includes a horizontal part, which is perpendicular to the central axis of the lens.

5. The lens according to claim 1, wherein the reflecting surface is shaped in a form of a overturned circular truncated cone.

6. The lens according to claim 1, wherein a side section of the reflecting surface includes at least two planes having mutually different gradients and being connected to each other.

7. The lens according to claim 1, wherein Ag or Al is coated or deposited on the reflecting surface.

8. The lens according to claim 1, wherein the reflecting surface and the refracting surface are symmetrically formed about the central axis of the lens, respectively.

9. The lens according to claim 1, wherein a vertical section of the refracting surface is formed as a part of a Bezier curve, an oval or a parabola.

10. The lens according to claim 1, wherein a groove is formed in the bottom surface about the central axis of the lens.

11. The lens according to claim 1, wherein the lens is made from light transmissive resin, which is one selected from the group consisting of cyclic olefin copolymer (COC), acryl resin, polycarbonate (PC), PC/PMMA copolymer, silicone, fluorocarbon resin, polyetherimide (PEI) and polynorbornene (PNB).

12. The lens according to claim 1, wherein an angle between a side section of the reflecting surface and the central axis of the lens is about 5 to 50°.

13. The lens according to claim 1, wherein the lens has a refractive index of about 1.3 to 1.8.

14. A light emitting device comprising a light emitting member and a side emitting lens,
wherein the side emitting lens comprises a bottom surface, a reflecting surface and a refracting surface,
wherein the reflecting surface is provided on an upper portion of the lens in a form of a recess, which is downwardly recessed towards the bottom surface about a central axis of the lens, and a sectional area thereof becomes reduced as it reaches the bottom surface,
the refracting surface extends from the bottom surface to the reflecting surface in a form of a curved surface, and
the light emitting member is installed on the bottom surface of the lens.

15. The light emitting device according to claim 14, wherein a groove for installing the light emitting member is formed at a center of the bottom surface.

16. The light emitting device according to claim 14, wherein a lower end portion of the reflecting surface has a sectional area smaller than that of a light emitting area of the light emitting member.

17. The light emitting device according to claim 14, wherein the light emitting member includes a light emitting diode (LED).

18. The light emitting device according to claim 15, wherein a molding member is filled in a gap formed between a groove formed in the bottom surface and the light emitting member.

19. A mold assembly for fabricating a lens having a bottom surface, a reflecting surface and a refracting surface, the mold assembly comprising:
a first mold having a cavity to form the reflecting surface and the refracting surface of the lens, and a second mold matching with the first mold and having a cavity to form a bottom surface of the lens,
wherein the section of the cavity of the first mold, which corresponds to the reflecting surface of the lens, is downwardly recessed about the central axis of the lens, and the sectional area thereof becomes reduced as it reaches the lower end portion of the cavity of the first mold, and
the section of the cavity of the first mold, which corresponds to the refracting surface of the lens, extends in the curved form from the external diameter portion of the cavity of the second mold, which corresponds to the bottom surface of the lens, to the section of the first mold, which corresponds to the reflecting surface of the lens.

20. The mold assembly according to claim 19, wherein the cavity of the second mold includes a receiving space for installing the light emitting member.

21. The mold assembly according to claim 19, wherein the cavity of the second mold includes a receiving space for a means for installing the light emitting member.

22. The mold assembly according to claim 21, wherein a groove is formed in the means for installing the light emitting member in order to fix the light emitting member.

23. The mold assembly according to claim 19, wherein the section of the cavity of the first mold, which corresponds to the reflecting surface of the lens, is pointed or flat at the end portion.

24. The mold assembly according to claim 19, wherein the first mold consists of at least two molds, each including at least one portion of the reflecting surface and the refracting surface.

25. The mold assembly according to claim 19, wherein the section of the first mold, which corresponds to the reflecting surface of the lens, include at least two planes having mutually different gradients and being connected to each other.

26. The mold assembly according to claim 19, wherein the section of the first mold, which corresponds to the refracting surface of the lens, has a vertical cross-section formed as a part of a Bezier curve, an oval or a parabola.

27. A method of fabricating a side emitting lens comprising:
forming a mold assembly by assembling the first mold and the second mold according to claim 19;
injecting a light transmissive resin into the cavity of the mold assembly; and
cooling the mold assembly, into which the light transmissive resin is injected, and taking out the lens formed by the light transmissive resin from the cavity of the mold assembly.

28. The method according to claim 27, wherein the light transmissive resin is selected from a group consisting of cyclic olefin copolymer (COC), acryl resin, polycarbonate (PC), PC/PMMA copolymer, silicon, fluorocarbon resin, polyetherimide (PEI) or polynorbornene (PNB).

29. A method of fabricating a side emitting light emitting device comprising:
disposing a light emitting member in the cavity of the first mold or the second mold of the mold assembly according to claim 19;
assembling the other piece mold with the first mold or the second mold in which the light emitting member is disposed to form a mold assembly;
injecting a light transmissive resin into the cavity of the assembled mold assembly; and
cooling the mold assembly, into which the light transmissive resin is injected, and taking out the lens formed by the light transmissive resin from the cavity of the mold assembly.

30. The method according to claim 29, wherein the light emitting member is a light emitting diode.
